(19) United States
(12) Patent Application Publication
(10) Pub. No.: US 2008/0282505 A1
(43) Pub. Date: Nov. 20, 2008

(54) REFRIGERATOR AND DOOR HANDLE FOR REFRIGERATOR

(76) Inventor: Jin Man KIM, Changwon-si (KR)

Correspondence Address: BIRCH STEWART KOLASCH & BIRCH, PO BOX 747, FALLS CHURCH, VA, 22040-0747, US

(21) Appl. No.: 12/120,072

(22) Filed: May 13, 2008

(30) Foreign Application Priority Data
May 14, 2007 (KR) 10-2007-0046388

(51) Int. Cl. E05B 1/00; A47B 96/04

(52) U.S. Cl. 16/412; 312/405

(57) ABSTRACT

Provided is a refrigerator with an opening assist formed of a connecting rod and a pushrod built into a door handle of the refrigerator. When rotated through a user's manipulation, one end of the opening assist selectively pushes the refrigerator main body to open the door. Thus, opening of a door is made easier to increase user convenience.

### CROSS-REFERENCE TO RELATED APPLICATIONS

The present application claims priority under 35 U.S.C. 119 and 35 U.S.C. 365 to Korean Patent Application No. 10-2007-0046388 (May 14, 2007) which is hereby incorporated by reference in its entirety.

### BACKGROUND

The present disclosure relates to a refrigerator, and more particularly, to a refrigerator and a door handle for a refrigerator provided with an opening assist that converts a rotating movement, performed by a user after grasping the refrigerator door handle, to a linear movement to separate the door from the refrigerator main body.

In general, as an apparatus for storing foods at low temperatures, a refrigerator preserves food in a frozen or refrigerated state according to the type and condition of the food.

For this end, cold air that is supplied into a refrigerator is generated through heat exchange of refrigerant by performing a repeating compression-condensation-expansion-evaporation cycle of refrigerant. In this way, heat exchange with the inside of the refrigerator is continuously performed to maintain food inside the refrigerator at a desired storage temperature.

Due to changes in eating habits and broadening palates of consumers, refrigerators that operate as described above are being enlarged and given more functions. Accordingly, the positions of refrigeration and freezer compartments and the structures of doors that open and close storage compartments have been diversified.

Specifically, refrigerators can now be categorized largely into a top mount refrigerator (the most proliterously used type with the freezer compartment above the refrigeration compartment), a bottom freezer refrigerator (with the freezer compartment below the refrigeration compartment), and a side-by-side refrigerator (with the freezer and refrigeration compartments to the left and right of one another). Moreover, specialty refrigerators have been introduced that are configured specifically for the type of items they are intended to storer such as kimchi refrigerators for preserving kimchi and wine refrigerators for preserving wine.

These various types of refrigerators have doors for opening and closing storage spaces defined within, which include doors that pivot left and right or upward and downward to open and close, and drawer type doors that slide forward and backward to open and close.

Such doors have a graspable handle installed to allow a user to more easily open and close the door by first grasping the door handle and pivoting or withdrawing the door to selectively open or close a storage space.

However, in the above related art refrigerator, the following limitations are inherent.

When a user grasps a door handle and pulls the door in one direction to open a storage space of a refrigeration compartment, because a gasket is pressed between the rear surface of the refrigerator door and the refrigerator main body, a pulling force must be exerted that is sufficient to release the coupling force between the gasket and the main body in order to open the door.

In particular, in the cases where a plurality of storage spaces is provided at the rear surfaces of the doors in a double French door configuration, and a plurality of food types is stored in the storage spaces, the force that a user must exert to pivot a door is greater.

Also, because larger refrigerators have heavier doors, and pressure within a refrigerator drops when the inner temperature drops so that the door and main body are pressed more firmly together, the act of opening a door may be difficult for some users according to gender, age, etc., thus lowering convenience of use.

Moreover, because the inside of a refrigerator is lower in pressure than the outside atmosphere, when a door is opened under these conditions, inertia at the opening position subjects the door to shock, which can lead to foodstuffs held insecurely in storage spaces at the rear surface of the door being dislodged and falling.

### SUMMARY

Embodiments provide a refrigerator and a door handle for a refrigerator.

In one embodiment, a refrigerator includes: a main body provided with a storage space; a door opening and closing the storage space; a door handle mounted on the door, to grasp when opening the door; and an opening assist provided to the door handle, to linearly move to separate the main body and the door when a user grasps and rotates the opening assist.

In another embodiment, a refrigerator includes: a main body; a door mounted on the main body; a cylindrical grip provided at a front of the door, for a user to grasp; an extension member respectively coupled at a top and bottom of the grip such that the grip is rotatable, and formed extending from the door, to mount the grip on the door in a separated manner; a rotating plate fixedly mounted to at least one of an upper surface and a lower surface of the grip to rotate in concert with the grip; and a pushrod pivotably coupled to one side offset from a rotation center of the rotating plate, and extending a predetermined length to selectively push against the main body to open the door, according to a rotation of the grip.

In a further embodiment, a refrigerator door handle includes: a cylindrical grip extending in a longitudinal direction of a door; an extension member provided on the door to support a top and a bottom of the grip and separate the grip from the door; a shaft respectively provided between the extension member and upper and lower surfaces of the grip, the shaft being a rotation axis of the grip to enable the grip to be rotated; and a pushrod pivotably coupled to the upper or lower surface of the grip at a distance from the shaft and extending toward the main body, to selectively push against the main body according to a rotation of the grip.

In a still further embodiment, a refrigerator includes: a main body; a door selectively opening and closing a storage space of the main body; a driving member having at least a partial sectional shape of a cam, to grasp when opening the door; an extension member mounted to rotatably support the driving member on the door; and a driven member having one end contacting an outer periphery of the driving member, to press against the main body and open the door by being moved linearly when the driving member is rotated.

The details of one or more embodiments are set forth in the accompanying drawings and the description below. Other features will be apparent from the description and drawings, and from the claims.

### BRIEF DESCRIPTION OF THE DRAWINGS

FIG. 1 is a side view showing the exterior of a refrigerator according to the present disclosure.

FIG. 2 is a side view showing the configuration of a door handle of a refrigerator according to the present disclosure.

FIGS. 3 and 4 are cross-sectional views showing the operation of an opening assist of the door handle shown in FIG. 2.

FIG. 5 is a side view showing a refrigerator according to the present disclosure about to be opened.

FIG. 6 is a cross-sectional view showing the configuration of an opening assist for a refrigerator according to another embodiment of the present disclosure.

### DETAILED DESCRIPTION OF THE EMBODIMENTS

Reference will now be made in detail to the embodiments of the present disclosure, examples of which are illustrated in the accompanying drawings. However, the present disclosure is not limited to embodiments provided herein, and may easily include other embodiments that fall within the spirit and scope of other, retrogressive inventions or the present disclosure, through the addition, modification, or deletion of elements.

For example, the present disclosure may be applied to any type of refrigerator provided with a door, regardless of the configuration of the refrigerator; however, for apprehension and descriptive convenience, the descriptions below will be based on a top mount refrigerator.

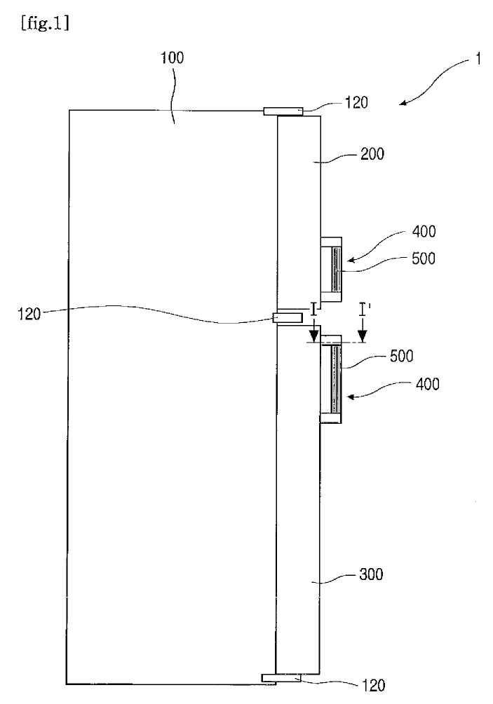

FIG. 1 is a side view showing the exterior of a refrigerator according to the present disclosure.

As shown in FIG. 1, the exterior of a refrigerator 1 according to the present disclosure is constituted by a main body 100 in an approximately hexahedral shape, and doors 200 and 300 for selectively opening and closing the main body 100.

The main body 100 includes a barrier that partitions its interior vertically into a freezer compartment for storing food at freezing temperatures above, and a refrigeration compartment for storing food at refrigerated temperatures below. Cold air is supplied respectively to the freezer compartment and the refrigeration compartment to maintain foods therein at respectively different temperatures.

The doors 200 and 300 consist of a freezer compartment door 200 that opens and closes the freezer compartment and a refrigerator compartment door 300 that opens and closes the refrigeration compartment by means of a hinges 120, such that the doors 200 and 300 can pivot about one side of the main body 100.

The doors 200 and 300 are provided with door handles 400. When viewed from the side, the door handles 400 include portions thereof that are separated from the front surfaces of the doors 200 and 300 to facilitate grasping thereof by a user.

The door handles 400 are configured with extension members 410 extending from the front surfaces of the doors 200 and 300 in vertical alignment, grips 530 respectively attached between one extension member 410 and another extension member 410, and opening assists 500 including the grips 530.

The central portion of the door handle 400 is formed with part of the opening assist 500 (to be described in detail below), and the remaining portions of the opening assist 500 are provided within the upper and lower parts of the door handle 400.

Below, the above-configured opening assist 500 will be described in detail with reference to the drawings.

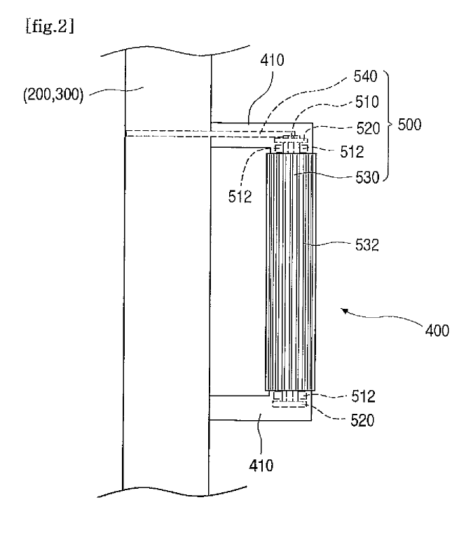

FIG. 2 is a side view showing the configuration of a door handle of a refrigerator according to the present disclosure.

As shown in the drawings, the opening assist 500 is constituted of a grip 530 rotated by a user's manipulation, a rotating plate 520 rotating in concert with the grip 530, a shaft 510 forming a rotation axis of the grip 530 and the rotating plate 530, and a pushrod 540 mounted on the shaft 510 to selectively separate the main body 100 and the door 200 or 300.

In further detail, the grip 530 forms the central portion of the door handle 400 and is configured to receive the shaft 510 installed in its upper and lower surfaces. Here, the grip 530 uses the shaft 510 as its axis of rotation, and is installed to rotate freely.

Also, the outer periphery of the grip 530 has an anti-slip recess 532 recessed therein to prevent a user's hands from slipping when the user grasps and rotates the grip 530. The anti-slip recess 532 may be defined in plurality, and may be defined in a longitudinal direction of the grip 530, as shown in the diagrams.

The shaft 510 is passed through the rotating plate 520 and inserted in the upper surface of the grip, with portions extending upward and downward from the grip 530, respectively. Also, the rotating plate 520 is mounted on the shaft 510 to be spaced above and below the upper surface and lower surface of the grip, respectively.

The rotating plate 520 is formed as a circular plate, and is maintained a predetermined distance apart from the grip 530 by a guide member 510 provided above the grip, and rotates in concert with the grip 530 by means of the shaft 510.

The guide member 512 can maintain a gap between the grip 530 and the rotating plate 520, and may be configured with a bearing that enables the grip 530 to rotate more smoothly.

Also, the above rotating plate 520 has a pushrod 540 fixed thereon. The pushrod 540 passes through the door 200 and 300 at points where the door handles 400 are fastened to the doors 200 and 300. In order to contact the main body 100, the pushrod 540 has a length enabling it to pass through the extension member 410 and the door 200 or 300, and selectively protrude from the rear of the door.

The pushrod 540 and rotating plate 520 are coupled with a fixing pin 550, and the fixing pin 550 is mounted in a position that biases to the left or right from the central rotation axis of grip 530, according to the rotated direction of the grip 530.

That is, as shown in the diagrams, in the case where the door handle 400 is disposed on the left of the door 200 or 300, and a user grasps and pulls the door 200 or 300, the door handle 400 rotates counterclockwise. Here, the pushrod 540 is pivotably coupled to the rotating plate 520 to right of the rotation center of the grip 530, such that the rotation of the handle 400 is converted to linear forward and rearward movement of the pushrod 540.

Of course, the pushrod 540 may be mounted on the upper surface or the lower surface of the grip 530 instead of on the rotating plate 520, in which case the pushrod 540 is also coupled at a position to one side apart from the rotation center of the grip 530. Needless to say, the rotating plate 520 need not be included in this case.

A through-hole 320 is defined from front-to-rear in the door 200 or 300 at the portion where the door handle 400 is fastened, and the through-hole 320 may be positioned at the upper or lower portion to communicate with the extension member 410 according to where the pushrod 540 is installed.

Below, the operation of the opening assist of the above-configured refrigerator according to the present disclosure will be described, when manipulation for opening the door is performed.

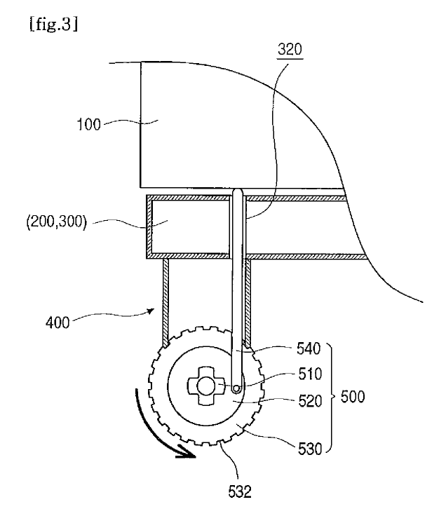

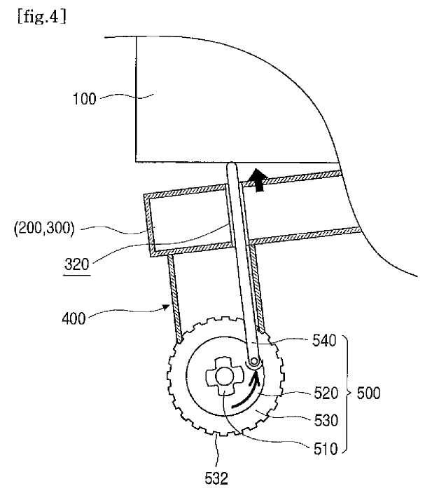

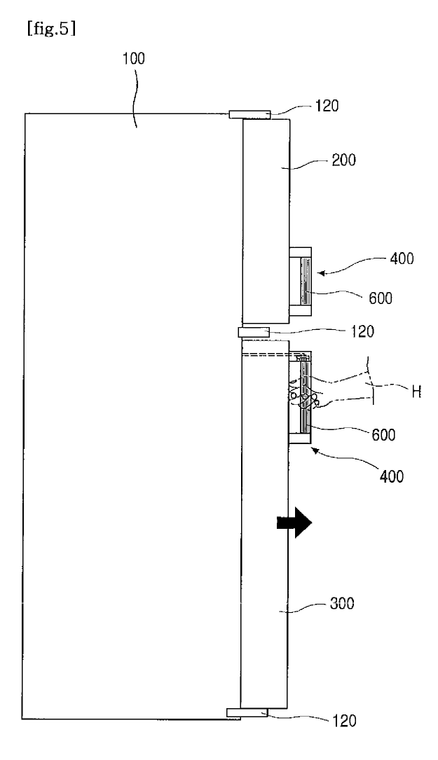

FIGS. 3 and 4 are cross-sectional views showing the operation of an opening assist of the door handle shown in FIG. 2, taken along line I-I′ in FIG. 1, and FIG. 5 is a side view showing a refrigerator according to the present disclosure about to be opened.

As shown in the diagrams, in order to open the door 200 or 300, a user grasps the door handle 400 and pulls it forward. Here, when the user grasps and pulls the door handle 400 forward, the grip 530 rotates counterclockwise while gripped by the user.

When the grip 530 is thus rotated counterclockwise, the rotating plate 520 concentric with the shaft 510 rotates in the same direction, and the pushrod 540 fixedly installed on the rotating plate 520 is moved linearly toward the main body 100 by the rotating plate 520.

Ultimately, the pushrod 540 contacts and presses against the main body 100, enabling the door 200 or 300 to be separated a predetermined distance from the main body 100. Thus, the sealing of the storage space within the main body 100 by the door 200 or 300 is negated to equalize the inside and outside pressures of the refrigerator, allowing for easier opening of the door 200 or 300.

Alternatively, should the pushrod 540 be located at the left from the center of the rotating plate 520 instead of its position shown in FIGS. 3 and 4, a user can rotate the grip 530 clockwise to more easily open the door 200 or 300 using the above-described opening assist 500. This configuration would be more beneficial for left-handed users.

In contrast to the above-described embodiments according to the present disclosure, a refrigerator may be configured such that its door can be easily opened by means of an opening assist, regardless of the rotated direction of the grip. A detailed description of such a configuration will be provided below.

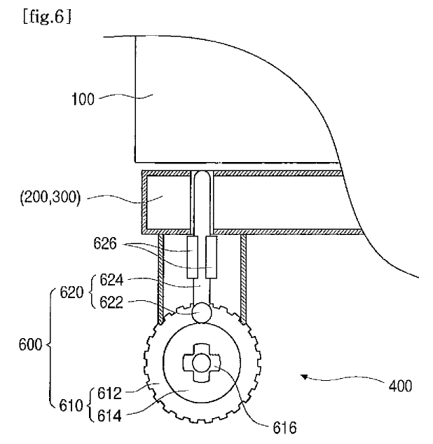

FIG. 6 is a cross-sectional view showing the configuration of an opening assist for a refrigerator according to another embodiment of the present disclosure.

Referring to the FIG. 6, an opening assist 600 according to another embodiment is configured with a driving member 610 formed at the central portion of the door handle 400, and a driven member 620 contacting the driving member 610 and sliding forward and rearward according to the rotation of the driving member 610.

In more detail, the driving member 610 includes a grip 612 forming the center of the door handle 400 and rotated by a user's manipulation, and a cam 614 formed at the top of and integrally with the grip 612 and contacting the driven member 620.

A rotating shaft 616 may be mounted at the center of the driving member 610 to enable the driving member 610 to rotate together with the grip 612, and the grip 612 and driving member 610 are configured to rotate together about the rotating shaft 616.

The rotating shaft 616 is inserted in the rotation center of the grip of the driving member 610, has a full length through the grip with portions projecting from the upper and lower surfaces of the grip, and is rotatably fixed to the door handle 400.

That is, a guide member is provided at the upper and lower portions of the door handle 400, with bearing components formed at portions where the rotating shaft 616 is fixed, thereby enabling the rotating shaft 616 to be rotatably fixed. Also, the driving member 610 may be integrally formed with the head portion of the rotating shaft 616.

The grip 612 has an anti-slip recess defined therein to prevent slipping when a user grasps the grip 612. The anti-slip recess may be a recess (as described in above embodiments), or may be perforations defined in longitudinal directions in the grip at predetermined intervals laterally therebetween.

A cam 614 is formed on at least a side of the upper surface and lower surface of the grip 612. The cam 614 has a sectional shape of a cam that contacts the driven member along its outer periphery during rotation of the driving member 610 to enable linear, reciprocal movement of the driven member 620.

Here, the cam 614 may be an elliptically shaped plate, or any other shape that can linearly reciprocate the driven member 620 when rotated.

The driven member 620 is configured with a contacting part 622 contacting the cam 614, and a pushrod 624 connected to the contacting part 622 to slide forward and rearward within the door handle 400 and the door 200 or 300.

In further detail, the contacting part 622 rolls along the outer periphery of the cam 614. When the cam 614 rotates, a positional displacement of the contacting part 622, due to a varying distance between the contacting point of the cam 614 and the contacting part 622 and the rotating center of the cam 614, is transferred to the pushrod 624.

The contacting part 622 may be round in shape to more easily slide over the outer periphery of the cam 614, and may be a roller and bearing configuration.

A slide guide 626 that encloses either side of the pushrod 624 is formed within the door handle 400, to enable the pushrod 624 to slide forward and rearward within the door handle 400 and door 200 or 300 according to the positional shift of the contacting part 622.

Specifically, the pushrod 624 slides toward the main body 100 by means of the rotation of the driving member 610 while held by the slide guide 626 provided inside the door handle 400 in order to open the door 200 or 300, and slides away from the main body 100 when closing the door 200 or 300.

Accordingly, the pushrod 624 is formed of an overall length such that it is flush with the rear surface of the door 200 or 300 and contacts the cam 614, as shown in FIG. 6, when the main body 100 and door 200 or 300 are sealed together.

Below, the operation of the above-configured opening assist 600 will be described.

In order to open a door 200 or 300 of a refrigerator employing an opening assist 600 according to an embodiment of the present disclosure, a user grasps and rotates the door handle 400 in any one direction. When the driving member 610 is thus rotated, the shape of the cam 614 prompts the contacting point between the contacting part 622 of the driven member 620 and the cam 614 to be displaced in position, whereby the pushrod 624 is moved toward the main body 100.

Here, the slide guide 626 provided inside the door handle 400 guides the pushrod 624 in one direction so that the latter does not wobble laterally, and the thus guided pushrod 624 contacts a predetermined part of the main body 100 to separate the door 200 or 300 from the main body 100 by the distance by which the above described contacting point is displaced.

When the door 200 or 300 is thus separated from the main body 100, the difference in inner and outer pressures of the refrigerator is equalized, facilitating opening of the door 200 or 300.

Through the operation of the opening assist 600 described above, a user can easily open the door 200 or 300 to store or remove food. When the door 200 or 300 is pivoted to re-seal the inner space of the main body 100, the end of the pushrod 624 protruding rearward from the door 200 or 300 contacts the main body 100.

Therefore, the pushrod 624 is pushed by the main body 100 to slide rearward and resume its original position. Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

For example, the shapes of the rotating plate 520 and the cam 614 of the driving member 610 may be formed asymmetrically instead of being rounded or elliptical, and the pushrod 540 may have a curved shape instead of being a straight bar.

In a thus configured refrigerator 1 according to the present disclosure, when a user grasps and pulls the door handle 400, the grip 530 or the driving member 610 of the opening assist 600 forming a portion of the door handle 400 is rotated, and this rotation prompts the pushrod 540 to slide forward to separate the door 200 or 300 from the main body 100.

Thus, when the door 200 or 300 and the main body 100 are separated, air from the outside quickly enters the refrigerator to equalize inner and outer pressure and open the door 200 or 300, so that a user can exert less force on the door 200 or 300 to open it.

Further, when the above door 200 or 300 and main body 100 are separated a predetermined distance to equalize inner and outer pressure of the refrigerator and open the door 200 or 300, shock imparted on the door 200 or 300 (from when the pressure inside the refrigerator is maintained) is reduced. Thus, food stored in the storage space provided at the rear surface of the door 200 or 300 can be more securely removed.

Any reference in this specification to “one embodiment,” an embodiment,” exemplary embodiment,” etc. means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

What is claimed is:

1. A refrigerator comprising:
a main body provided with a storage space;
a door opening and closing the storage space;
a door handle mounted on the door, to grasp when opening the door; and
an opening assist provided to the door handle, to linearly move to separate the main body and the door when a user grasps and rotates the opening assist.

2. The refrigerator according to claim 1, wherein the opening assist comprises:
a grip rotatably mounted at the door handle, for a user to grasp when opening the door; and
a pushrod pivotably coupled to one side offset from a rotation center of the grip, to be passed through the door and selectively contacted with the main body.

3. The refrigerator according to claim 2, wherein the grip comprises a plurality of anti-slip recesses defined in a surface thereof.

4. The refrigerator according to claim 2, wherein the door handle comprises an extension member provided respectively at a top and bottom of the grip, such that the grip is mounted in a separated manner from the door.

5. The refrigerator according to claim 2, wherein the pushrod is configured to pass sequentially through an inside of the door handle and the door.

6. A refrigerator comprising:
a main body;
a door mounted on the main body;
a cylindrical grip provided at a front of the door, for a user to grasp;
an extension member respectively coupled at a top and bottom of the grip such that the grip is rotatable, and formed extending from the door, to mount the grip on the door in a separated manner;
a rotating plate fixedly mounted to at least one of an upper surface and a lower surface of the grip to rotate in concert with the grip; and
a pushrod pivotably coupled to one side offset from a rotation center of the rotating plate, and extending a predetermined length to selectively push against the main body to open the door, according to a rotation of the grip.

7. The refrigerator according to claim 6, further comprising a shaft passing through a center of the rotating plate and fastened at a center of the upper or lower surface of the grip.

8. The refrigerator according to claim 7, further comprising a guide member formed between the rotating plate and the grip to separate the rotating plate from a surface of the grip, to smoothly guide a rotation of the grip.

9. The refrigerator according to claim 6, wherein the grip is disposed between the extension members, and the rotating plate is disposed to an inside of the extension members.

10. The refrigerator according to claim 6, wherein the pushrod is pivotably coupled at a point offset to a right of the rotation center of the rotating plate.

11. The refrigerator according to claim 6, wherein the rotating plate is circularly or elliptically shaped.

12. A refrigerator door handle comprising:
a cylindrical grip extending in a longitudinal direction of a door;
an extension member provided on the door to support a top and a bottom of the grip and separate the grip from the door;
a shaft respectively provided between the extension member and upper and lower surfaces of the grip, the shaft being a rotation axis of the grip to enable the grip to be rotated; and
a pushrod pivotably coupled to the upper or lower surface of the grip at a distance from the shaft and extending toward the main body, to selectively push against the main body according to a rotation of the grip.

13. The refrigerator door handle according to claim 12, wherein the extension member is hollow inside, and the pushrod is disposed within the extension member.

14. The refrigerator door handle according to claim 12, further comprising a rotating plate provided at the upper or lower surface of the grip to have the same rotation center as the grip, wherein the pushrod is pivotably coupled to the rotating plate at a position offset from the rotation center.

15. The refrigerator door handle according to claim 14, wherein the extension member is hollow inside, and the rotating plate and the pushrod are disposed within the extension member.

16. The refrigerator door handle according to claim 12, wherein the pushrod is mounted through the door.

17. A refrigerator comprising:
a main body;
a door selectively opening and closing a storage space of the main body;
a driving member having at least a partial sectional shape of a cam, to grasp when opening the door;
an extension member mounted to rotatably support the driving member on the door; and
a driven member having one end contacting an outer periphery of the driving member, to press against the main body and open the door by being moved linearly when the driving member is rotated.

18. The refrigerator according to claim 17, wherein the driving member comprises:
a grip formed vertically elongated, for a user to grasp; and
a cam having a sectional cam profile, and provided at least at one of an upper and lower surface of the grip, the cam maintaining contact with the end of the driven member.

19. The refrigerator according to claim 18, wherein the cam is elliptical in shape.

20. The refrigerator according to claim 17, wherein the driven member comprises:
a pushrod selectively contacting the main body, to press against the main body; and
a contacting part provided on one end of the pushrod, to contact an outer periphery of a cam-shaped portion of the driving member.

21. The refrigerator according to claim 20, wherein the pushrod is mounted through a sealed passage defined by the extension member and the door, and is guided in movement by a slide guide enclosing an outer periphery thereof.

22. The refrigerator according to claim 20, wherein the contacting part is round in shape and rotatably mounted at the end of the pushrod.

23. The refrigerator according to claim 20, further comprising an elastic member provided on the door or the extension member, to move the driven member out of contact with the main body.
